(19) United States
(12) Patent Application Publication
(10) Pub. No.: US 2018/0011580 A1
(43) Pub. Date: Jan. 11, 2018

(54) SYSTEMS AND METHODS FOR PREVIEWING AND SCRUBBING THROUGH MEDIA CONTENT ITEMS

(71) Applicant: Facebook, Inc., Menlo Park, CA (US)

(72) Inventors: Daniel Benjamin Lebowitz, Mountain View, CA (US); John Evans, San Francisco, CA (US); Zhisheng Huang, Sunnyvale, CA (US); Adam Johnathan Peter Bell, Menlo Park, CA (US)

(21) Appl. No.: 15/203,423

(22) Filed: Jul. 6, 2016

(51) Int. Cl. G06F 3/041; G06F 3/0485; G06F 3/0484; G06F 3/0488; G06F 3/0482

(52) U.S. Cl. CPC G06F 3/0414; G06F 3/0488; G06F 3/0482; G06F 3/04842; G06F 3/0485

(57) ABSTRACT

Systems, methods, and non-transitory computer-readable media can display a collection of media content items. A pressure-based user interaction is received via a graphical user interaction, the pressure-based user interaction identifying a first media content item of the collection of media content items. A preview pane displaying the first media content item is displayed in response to the pressure-based user interaction. A position-based user interaction is received via the graphical user interface. A second media content item is displayed in the preview pane in response to the position-based user interaction.

### FIELD OF THE INVENTION

The present technology relates to the field of graphical user interfaces. More particularly, the present technology relates to a graphical user interface for previewing and scrubbing through media content items.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with an application to view and interact with the social networking system. For example, the application can be a mobile application on a user's mobile device. The application can include a graphical user interface, which provides users with the ability to view and otherwise interact with content on the social networking system, such as media content items posted to the social networking system by other users. For example, a user can view photos and videos or listen to audio files posted by other users.

### SUMMARY

Various embodiments of the present disclosure can include systems, methods, and non-transitory computer readable media configured to display a collection of media content items. A pressure-based user interaction is received via a graphical user interface, the pressure-based user interaction identifying a first media content item of the collection of media content items. A preview pane displaying the first media content item is displayed in response to the pressure-based user interaction. A position-based user interaction is received via the graphical user interface. A second media content item is displayed in the preview pane in response to the position-based user interaction.

In an embodiment, the pressure-based user interaction satisfies a first pressure threshold.

In an embodiment, an indication that the pressure-based user interaction no longer satisfies the pressure threshold is received, and the preview pane is no longer displayed.

In an embodiment, a second pressure-based user interaction that satisfies a second pressure threshold is received, and a stand-alone view of the second media content item is displayed in response to the second pressure-based user interaction satisfying the second pressure threshold.

In an embodiment, the second media content is displayed in the preview pane in response to the position-based user interaction and continued receipt of the pressure-based user interaction.

In an embodiment, the position-based user interaction comprises a change in position of the pressure-based user interaction.

In an embodiment, the pressure-based user interaction satisfies a pressure threshold, and the position-based user interaction comprises a change in position of the pressure-based user interaction while the pressure-based user interaction continues to satisfy the pressure threshold.

In an embodiment, the position-based user interaction comprises a change in position of the pressure-based user interaction, and the displaying the second media content item in the preview pane occurs in response to the change in position of the pressure-based user interaction satisfying a distance threshold.

In an embodiment, the distance threshold is calculated based on a number of media content items in the collection of media content items.

In an embodiment, the second media content item comprises a video media content item, and the displaying the second media content item in the preview pane comprises playing the video media content item in the preview pane.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a preview and scrub module, according to an embodiment of the present disclosure.

FIG. 2 illustrates an example user input module, according to an embodiment of the present disclosure.

FIGS. 3A-3F illustrate an example scenario associated with previewing and scrubbing through media content items on a mobile device, according to an embodiment of the present disclosure.

FIG. 4 illustrates an example method for previewing media content items, according to an embodiment of the present disclosure.

FIG. 5 illustrates an example method for transitioning between a collection view, a preview view, and a stand-alone view, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Previewing and Scrubbing Through Media Content Items

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with an application to view and interact with the social networking system. For example, the application can be a mobile application on a user's mobile device. The application can include a graphical user interface, which provides users with the ability to view and otherwise interact with content on the social networking system, such as media content items posted to the social networking system by other users. For example, a user can view photos and videos or listen to audio files posted by other users.

It continues to be an important interest for a social networking system to encourage interaction between users and content on the social networking system. Continued user interaction with content posted to the social networking is an important aspect of maintaining continued interest in and participation on the social networking system. A related issue is the issue of providing users with a mobile application and graphical user interface that allows the user to view and interact with content on the social networking in an easy, intuitive manner. Conventional graphical user interfaces and their functionality can be unintuitive, cumbersome in navigation, visually unattractive, or otherwise functionally suboptimal, leading to frustration and loss of interest by users.

An improved approach rooted in computer technology overcomes the foregoing and other disadvantages associated with conventional approaches specifically arising in the realm of computer technology. Based on computer technology, the disclosed technology can utilize both pressure-based user input and position-based user input to allow a user to preview (or “peek” at) media content items, and scroll (or “scrub”) through multiple media content items in a simple, continuous motion. In this way, a user can, for example, be provided with a graphical user interface on his or her mobile device that allows the user to preview a media content item in a preview pane, and scroll through multiple media content items in the preview pane with a simple motion that can be performed using one hand. As discussed herein, user interactions with a media content item can refer to user actions and gestures applied to a screen (e.g., touchscreen) of a client device to interact with the media content item displayed in a graphical user interface presented through the screen by the client device. In certain embodiments, a user can be presented with a graphical user interface that presents a collection of media content items comprising a plurality of media content items. For example, the user can be presented with a photo album comprising a collection of photos and videos. The graphical user interface can include a collection view, a preview view, and a stand-alone view. The user can navigate from the collection view to the preview view, i.e., a view in which the user previews a particular media content item, based on a pressure-based user input. For example, the user can apply pressure to a selected media content item on the graphical user interface (e.g., using his or her finger) to open a preview pane in which an expanded view of the selected media content item is presented. When the user releases pressure, the graphical user interface migrates from the preview view back to the collection view. Within the preview view, the user can scroll through multiple media content items from the collection of media content items based on a position-based user input. For example, the user can preview a first media content item by applying pressure to the first media content item, and then scroll through multiple media content items by moving his or her finger horizontally while maintaining pressure. As the user changes the position of his or her finger on the graphical user interface (i.e., a position-based user input), the media content item presented in the preview view can change based on the change in position of the user's finger.

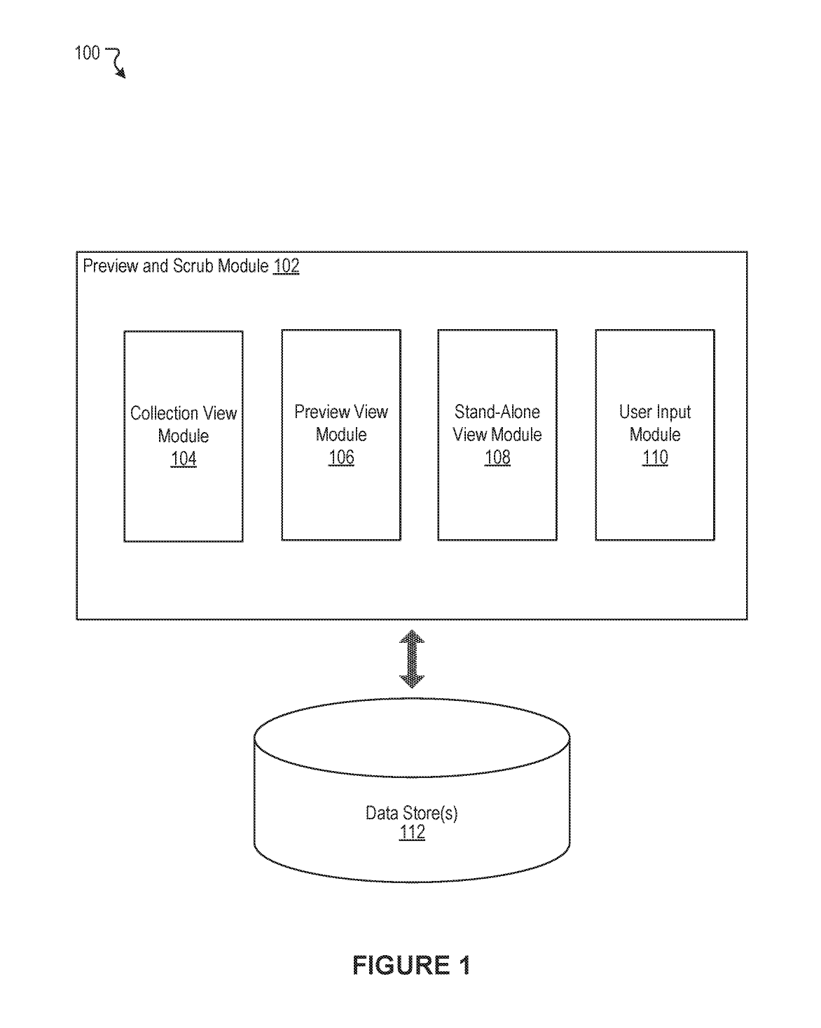

FIG. 1 illustrates an example system 100 including an example preview and scrub module 102 configured to provide a graphical user interface in which a user can preview and scrub through multiple media content items based on pressure-based and position-based user inputs, according to an embodiment of the present disclosure. The preview and scrub module 102 can be configured to provide a user interface in which a user is presented with a collection of media content items, and can interact with the collection of media content items. In certain embodiments, the preview and scrub module 102 can be configured to receive pressure-based user inputs and position-based user inputs, and to vary presentation of the collection of media content items (and the media content items contained therein) based on the pressure-based and position-based user inputs. In certain embodiments, the preview and scrub module 102 can transition between a collection view, a preview view, and a stand-alone view based on user input received. For example, the graphical user interface can transition from the collection view to the preview view when a user applies a first pressure satisfying a first pressure threshold. In certain embodiments, as the user gradually applies more and more pressure, the graphical user interface gradually transitions from the collection view to the preview view. Once the pressure applied exceeds the first pressure threshold, the graphical user interface transitions fully to the preview view. Within the preview view, the user can scrub between different media content items based on a position-based user input, e.g., by moving his or her finger horizontally on the graphical user interface.

The graphical user interface can transition from the preview view to the stand-alone view when the user applies a second pressure satisfying a second pressure threshold. For example, a user can apply light pressure to open a preview of a media content item, and then can apply additional pressure to open a stand-alone view of the media content item. The stand-alone view can comprise a graphical user interface page in which the media content item is presented, and the user can interact with the media content item by, for example, liking the media content item, commenting on the media content item, sharing the media content item, and the like. In certain embodiments, the stand-alone view can be distinguished from the preview view in that once the user stops applying pressure, the preview view will return to the collection view, whereas in the stand-alone view, the stand-alone view will continue to be shown even once the user has stopped applying pressure to the graphical user interface.

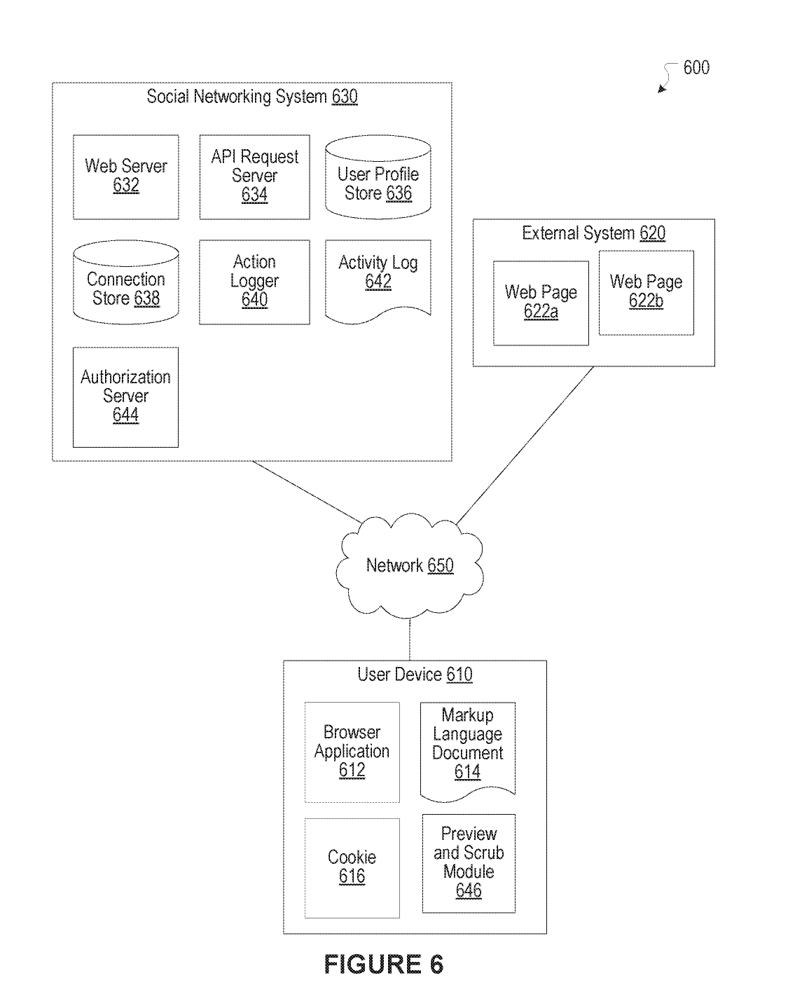

The preview and scrub module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the preview and scrub module 102 can be implemented, in part or in whole, as software running on one or more computing devices or systems, such as on a server computing system or a user (or client) computing system. For example, the preview and scrub module 102 or at least a portion thereof can be implemented as or within an application (e.g., app), a program, or an applet, etc., running on a user computing device or a client computing system, such as the user device 610 of FIG. 6. In another example, the preview and scrub module 102 or at least a portion thereof can be implemented using one or more computing devices or systems that include one or more servers, such as network servers or cloud servers. In some instances, the preview and scrub module 102 can, in part or in whole, be implemented within or configured to operate in conjunction with a social networking system (or service), such as the social networking system 630 of FIG. 6. It should be understood that there can be many variations or other possibilities.

As shown in the example of FIG. 1, the preview and scrub module 102 can include a collection view module 104, a preview view module 106, a stand-alone view module 108, and a user input module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

The preview and scrub module 102 can be configured to communicate and/or operate with the at least one data store 112, as shown in the example system 100. The data store 112 can be configured to store and maintain various types of data. In some implementations, the data store 112 can store information associated with a social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 112 can store information that is utilized by the peek and scrub module 102. For example, the data store 112 can store media content item information, media content item collections, graphical user interfaces, user preferences, and the like. It is contemplated that there can be many variations or other possibilities.

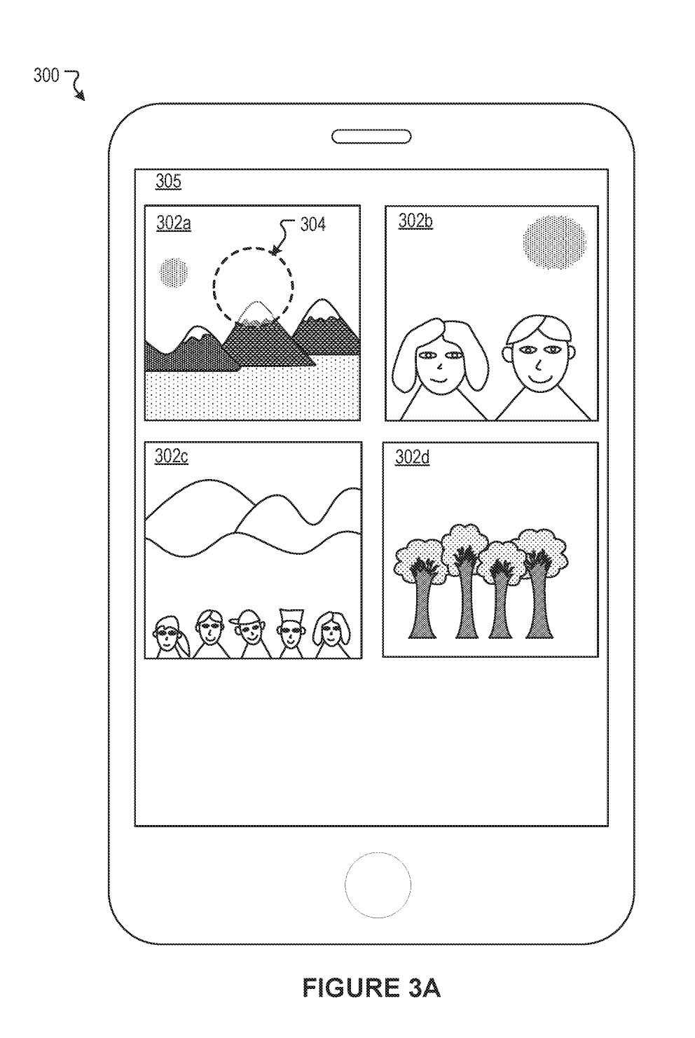

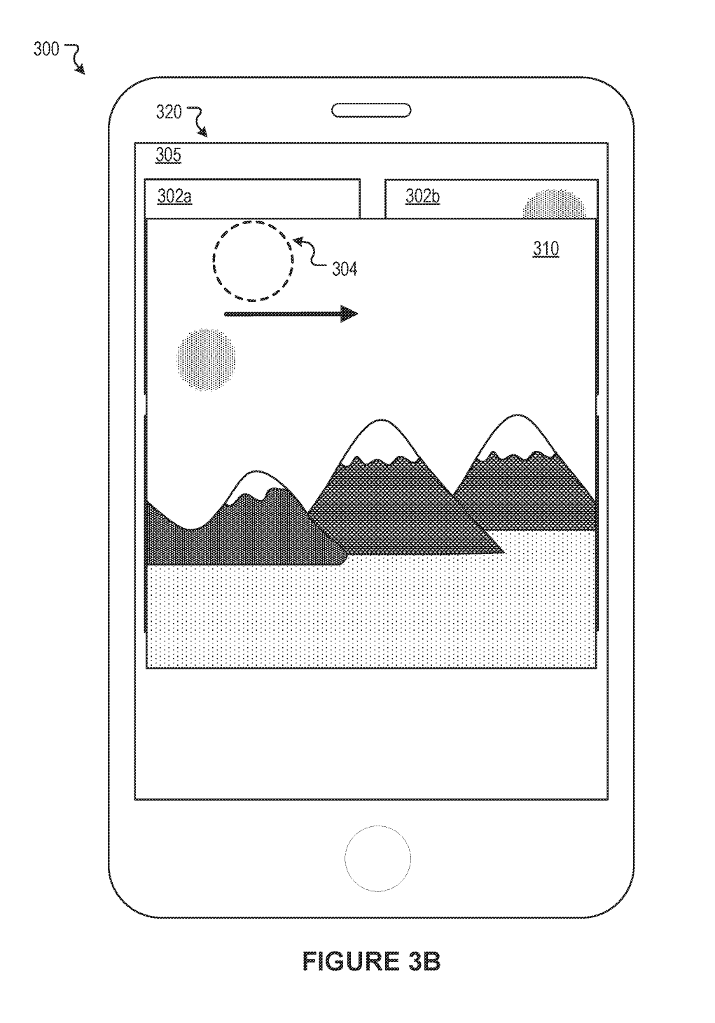

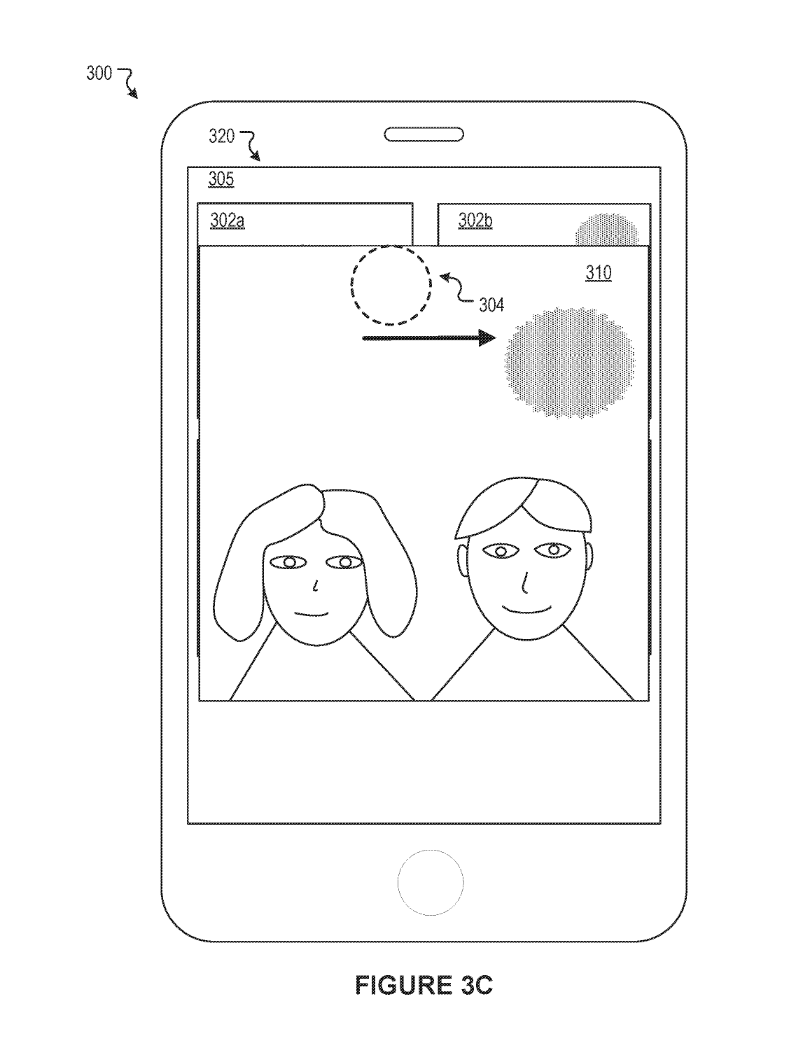

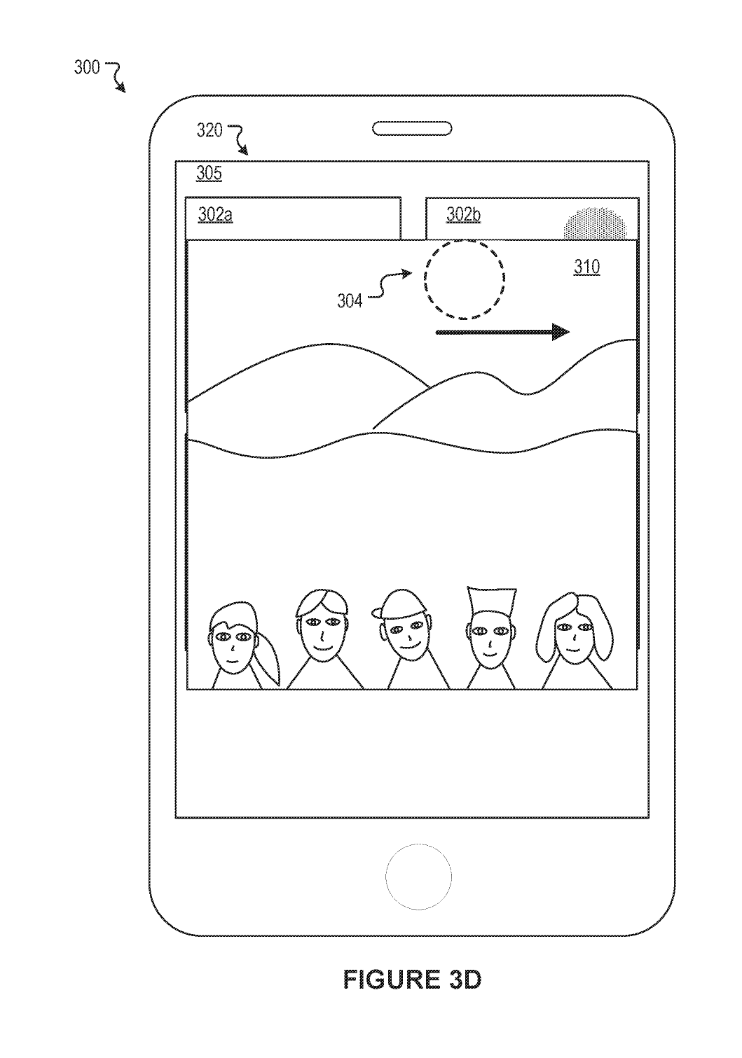

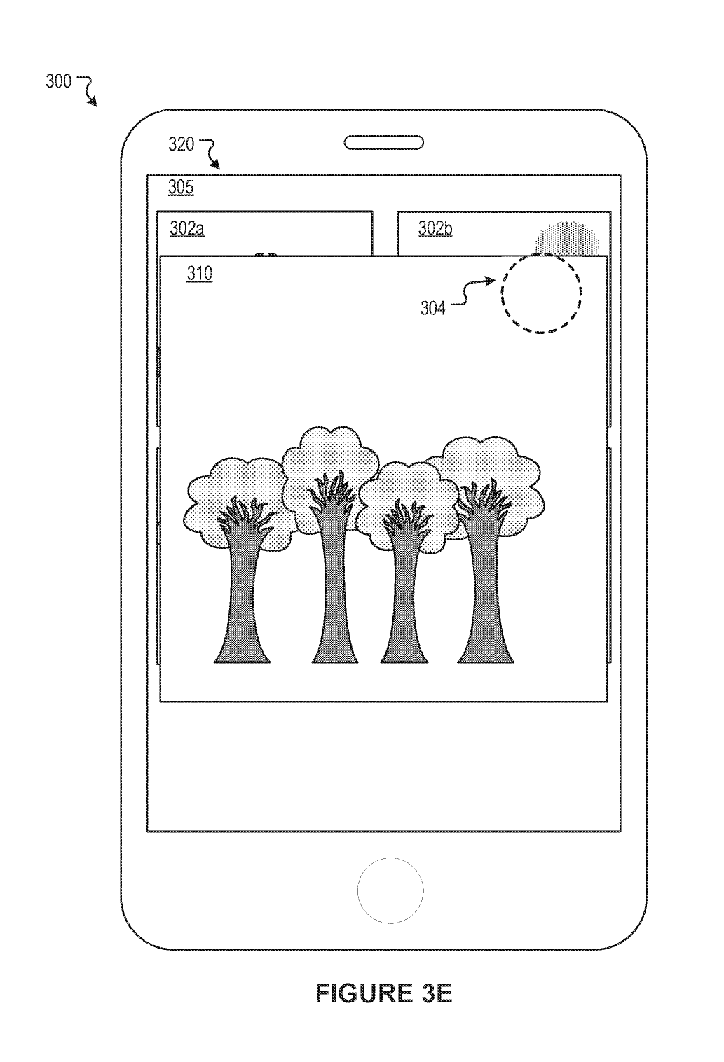

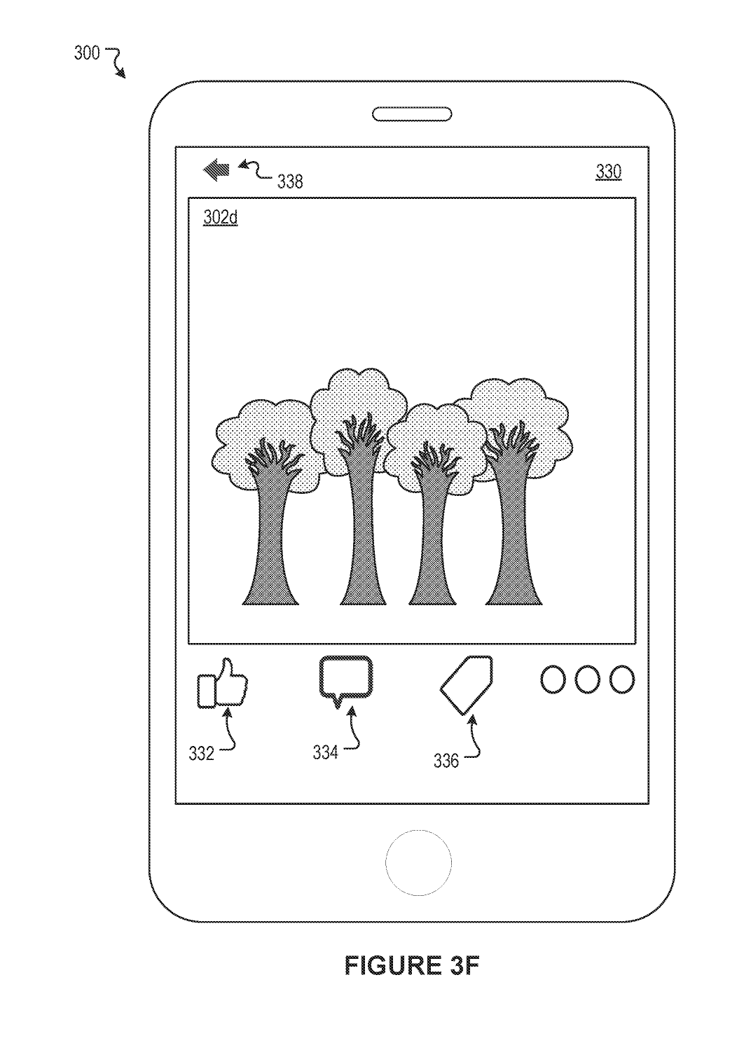

The collection view module 104 can be configured to provide a collection view to a user via a graphical user interface on the user's computing device. In certain embodiments, the collection view can present a collection of media content items comprising a plurality of media content items for viewing and interaction by a user. For example, the collection view can present thumbnail representations of the plurality of media content items in a grid that the user can scroll through. The user can interact with media content items presented in the collection view in various ways. For example, the user can slide his or her finger on the user interface to scroll through the collection view, or the user can tap on a media content item (e.g., its thumbnail representation) to open the media content item and/or a stand-alone view of the media content item. In another example, the user can open a preview view of a media content item by, for example, tapping and holding the media content item, or applying a threshold amount of pressure on the media content item. An example of a collection view is presented in FIG. 3A, which is discussed in greater detail below.

The preview view module 106 can be configured to provide a preview view to a user via a graphical user interface on the user's computing device. In certain embodiments, the user can transition to the preview view from the collection view by interacting with a particular media content item. For example, the user can tap and hold on a media content item to open up a preview view in which the media content item is shown in an expanded preview pane. In another example, the user can apply a threshold amount of pressure on a media content item to open up a preview of the media content item. When the user releases the pressure on the media content item (or stops holding their finger on the media content item), the graphical user interface can revert back to the collection view. Within the preview view, the user can be given the ability to scrub through multiple media content items. For example, if a user applies pressure to open up a preview pane of a first media content item in a media content item collection, the user can scroll his or her finger horizontally, while still applying pressure, to change the preview pane from displaying the first media content item to displaying another media content item in the media content item collection. In certain embodiments, as a user scrubs through media content items in the preview view, media content items can transition from one to the next based on an ordering of the media content items within the collection of media content items. In other words, media content items can be ordered within a collection of media content items such that scrubbing forwards or backwards through the collection of media content items results in a repeatable, predictable ordering of media content items. An example of a preview view is presented in FIGS. 3B-3E, which are discussed in greater detail below.

The stand-alone view module 108 can be configured to provide a stand-alone view of a media content item to a user via a graphical user interface on the user's computing device. In certain embodiments, providing a stand-alone view comprises providing a user interface page associated with a particular media content item. For example, from the collection view, if the user taps on a media content item, the user may be directed to a page that presents the media content item on a stand-alone page. In the stand-alone view, the user may be given the ability view the media content item, and to interact with the media content item, e.g., by liking, commenting on, sharing, or tagging the media content item. In certain embodiments, the user can transition from the collection view, to the preview view, to the stand-alone view by applying increasing pressure. For example, the user can apply an amount of pressure that exceeds a preview pressure threshold to move from the collection view to the preview view, and then an increased amount of pressure that exceeds a stand-alone pressure threshold to move from the preview view to the stand-alone view.

By implementing the features described above, the user can easily transition between a collection view, a preview view, and a stand-alone view. For example, the user can open a collection of media content items in a collection view. The user can preview a media content item by applying pressure to it, and then preview additional media content items in the collection by continuing to apply pressure and moving his or her finger around the graphical user interface. Once the user has arrived at a media content item that the user wishes to view and interact with, the user can apply additional pressure to open up a stand-alone view for that media content item.

The user input module 110 can be configured to receive user inputs via a graphical user interface on the user's computing device. The user input module 110 can be configured to receive the various user inputs described herein. For example, the user input module can receive pressure-based user inputs to transition between a collection view, a preview view and, a stand-alone view. The user can also receive position-based user inputs to, for example, scroll through a collection view, or scrub through different media content items while in the preview view. The user input module 110 is discussed in greater detail herein.

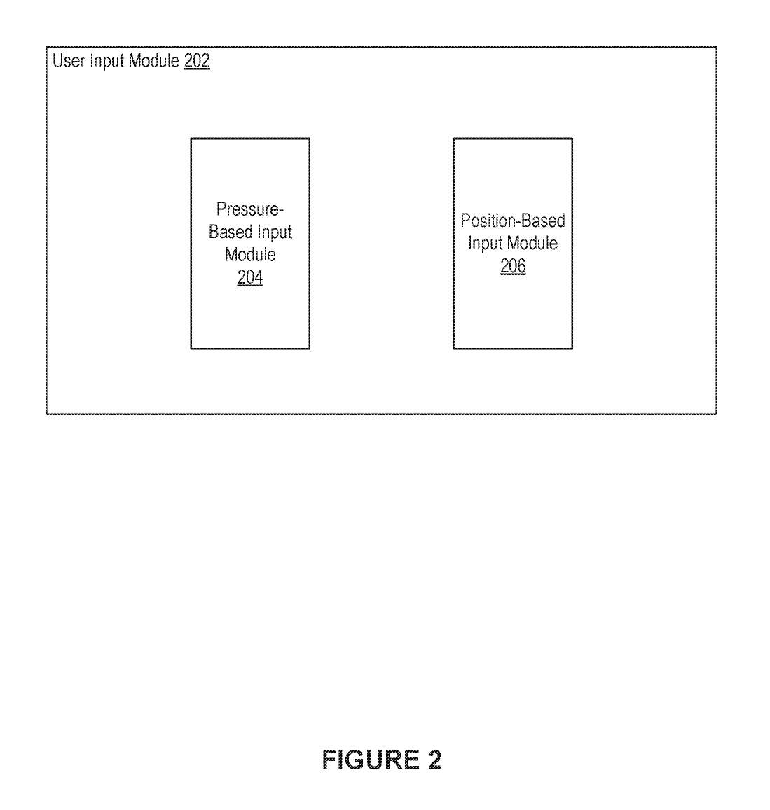

FIG. 2 illustrates an example user input module 202 configured to receive user inputs via a graphical user interface, according to an embodiment of the present disclosure. In some embodiments, the user input module 110 of FIG. 1 can be implemented as the example user input module 202. As shown in FIG. 2, the user input module 202 can include a pressure-based input module 204 and a position-based input module 206. The user input module 202 can be configured to receive various user inputs to carry out associated actions in a graphical user interface. For example, the user input module 202 can be configured to receive the various user inputs described herein.

The pressure-based input module 204 can be configured to receive pressure-based user inputs via a graphical user interface. In certain embodiments, pressure-based user inputs can include any user input in which pressure applied by a user is used as an input. This can include, for example, a user tapping on a touchscreen, or tapping and holding on the touchscreen. The pressure-based input module 204 can be further configured to determine varying levels of pressure applied by a user, and various actions can be taken based on the varying levels of pressure applied. For example, as discussed above, if a user applies a first amount of pressure on a graphical user interface by, for example, pressing on a touchscreen, a preview view can open if the amount of pressure applies satisfies a preview pressure threshold. Similarly, if the user applies a second amount of pressure that is greater than the first amount of pressure, and satisfies a stand-alone pressure threshold, a stand-alone view can open.

The position-based input module 206 can be configured to receive position-based user inputs via a graphical user interface. Position-based user inputs can include any user input based on a position of a user interaction on a graphical user interface and/or any change in position of a user interaction on a graphical user interface. For example, position-based user inputs can include a user tapping or tapping and holding on a particular location on a touchscreen, swiping his or her finger in a particular direction, or moving his or her finger from one position to another position on the graphical user interface. The position-based input module 206 can be configured to cause different actions to be taken based on various characteristics of the position-based user input. The actions taken can also be based on a current state of the graphical user interface. For example, a user tapping on a particular area of the graphical user interface in the collection view can cause a media content item displayed in the particular area to be opened. A user moving his or her finger vertically or horizontally in the collection view can cause the graphical user interface to scroll through the collection view. However, a user moving his or her finger vertically or horizontally in the preview view can cause the graphical user interface to scrub through multiple media content items by changing which media content item is displayed in a preview pane. Characteristics of a position-based user input can include the actual position of a user interaction on a graphical user interface (e.g., where on a touchscreen the user taps), a rate of change of position of a user interaction (e.g., the speed or acceleration of a user swiping), a direction of change of position of a user interaction (e.g., swiping left, right, up, or down, or in a circular pattern, etc.), and the like.

It should be understood that while various examples of user interactions have been grouped into “pressure-based” or “position-based” user interactions, certain interactions may be grouped into either category, while other interactions may be both pressure and position-based. For example, a user interaction based on a user tapping a screen, or tapping and holding, may be carried out based solely on the tap's position, rather than any pressure-based sensing. In another example, scrubbing through media content items in a preview pane can be caused by both applying pressure (to open the preview pane), and then changing the position of the user's finger as pressure continues to be applied.

FIGS. 3A-F illustrate an example scenario 300 associated with allowing a user to preview and scrub through media content items based on user input, according to an embodiment of the present disclosure. In FIG. 3A, a user mobile device displays a collection view 305 comprising a plurality of media content items 302a-d. It can be seen that the collection view 305 includes four images 302a-d in a grid format. If the collection included additional media content items, such that they could not fit onto the graphical user interface, these additional media content items could continue below the visible portion of the graphical user interface such that the user could scroll downward to see additional media content items.

In the collection view 305, the user has applied pressure to a first media content item 302a, as indicated by the dotted circle 304. By applying pressure to the first media content item 302a, the user causes the graphical user interface to transition to a preview view in which an expanded preview of the media content item 302a is presented.

FIG. 3B illustrates a preview view 320, in which a preview pane 310 displays an expanded version of the media content item 302a selected by the user. It can be seen that in FIG. 3B, the preview pane 310 is superimposed on top of the collection view 305. In certain embodiments, the collection view 305 can be presented in the background, while the preview view 320 and associated preview pane 310 are presented in the foreground. The collection view can be further obscured by blurring the collection view 305, de-saturating the collection view 305, or otherwise visually de-emphasizing the collection view 305.

In FIG. 3B, the user has opened a preview of media content item 302a in the preview pane 310 by applying a pressure that exceeds a first pressure threshold, i.e., a preview pressure threshold. The user can move to a stand-alone view of the media content item 302a by applying a greater pressure that exceeds a second pressure threshold, i.e., a stand-alone pressure threshold. Alternatively, the user can release pressure (e.g., by taking their finger off the screen) to cease display of the preview pane 310, e.g., by collapsing the preview pane 310 and returning to the collection view 305. The user can also change the position of his finger to scrub through other media content items. In FIG. 3B, it can be seen that the user is sliding his finger 304 horizontally to scrub to the next media content item.

In FIG. 3C, the user has change the position of his finger 304 sufficiently to invoke a preview of the next media content item 302b. The user continues to slide his finger 304 horizontally to invoke a preview of media content item 302c in FIG. 3D. Finally, in FIG. 3E, the user continues to slide his finger 304 horizontally, and reaches the final media content item of the collection, media content item 302d.

Scrubbing through media content items based on horizontal movement can be carried out in a number of different ways. In one embodiment, a user may be required to change the position of his or her input by a fixed threshold distance to change the previewed media content item. For example, a user may be required to move his or her finger 10% across the screen, or a threshold number of pixels, to move to the next media content item. In another embodiment, the threshold distance may be determined based on the number of media content items in the collection. For example, if there are four media content items in the collection, the threshold distance may be 25% of the screen, or 25% of the remaining distance from the user's current input position to the rightmost edge of the screen. If there are fifty media content items, then the threshold distance would become 2% of the screen, or 2% of the remaining distance from the user's current input position to the rightmost edge of the screen.

In FIG. 3E, the user has decided that he or she would like to further interact with the media content item 302d, and would like to view a full stand-alone view of the media content item 302d rather than a preview view. In order to do this, the user can apply greater pressure to open a stand-alone view 330 as seen in FIG. 3F. In the stand-alone view 330 of FIG. 3F, the user is provided with a fully expanded view of media content item 302d. The user can interact with the media content item by, for example, selecting a “like” icon 332, a “comment” icon 334, or a “tag” icon 336. The stand-alone view 330 also includes a back arrow 338 to allow the user to return to the collection view 305.

While the example of horizontal movement has been used to demonstrate position-based user input to scrub through multiple media content items, it should be understood that there are numerous other possibilities. For example, vertical movement could be used. In another example, a user could scrub through media content items in the preview view by moving his or her finger in a circular motion, and the threshold distance to advance to the next media content item could be based on a radial or angular distance.

The examples shown demonstrate that a user can advance “forward” to a next media content item in a media content item selection, but it should be understood that users can also move backwards in the collection. For example, a rightward horizontal movement may indicate forward progress while leftward horizontal movement can indicate backward progress, or clockwise rotation can indicate forward progress and counter-clockwise rotation backward progress.

Furthermore, while images have been used as examples for the present disclosure, media content items can comprise any media content item, such as images, videos, audio files, and the like. A preview of a video media content item may comprise playing the video content item in the preview pane 310. A preview of an audio media content item may comprise displaying a symbol indicating an audio media content item, and playing the audio media content item.

In certain embodiments, a user may also be given the ability not only to scrub from one media content item to another, but also to scrub through a particular media content item. For example, if a preview of a video media content item is being shown, the user's position-based input could be used to scrub through the video to fast forward or rewind the video. In one embodiment, a user can scrub through a particular media content item in the same way that the user scrubs from one media content item to another. For example, if rightward horizontal movement causes the user to move forward from one media content item in a collection to the next, then the user can continue moving his or her finger rightward to fast-forward through a video preview. Once the preview reaches the end of the video, continued rightward movement can cause the preview pane to display the next media content item. Alternatively, different user inputs can be used for scrubbing between multiple media content items, and scrubbing through a particular media content item. For example, a user can move his or her finger horizontally to scrub from one media content item to another, while circular rotation of his or her finger will cause the preview to fast forward or rewind a particular media content item.

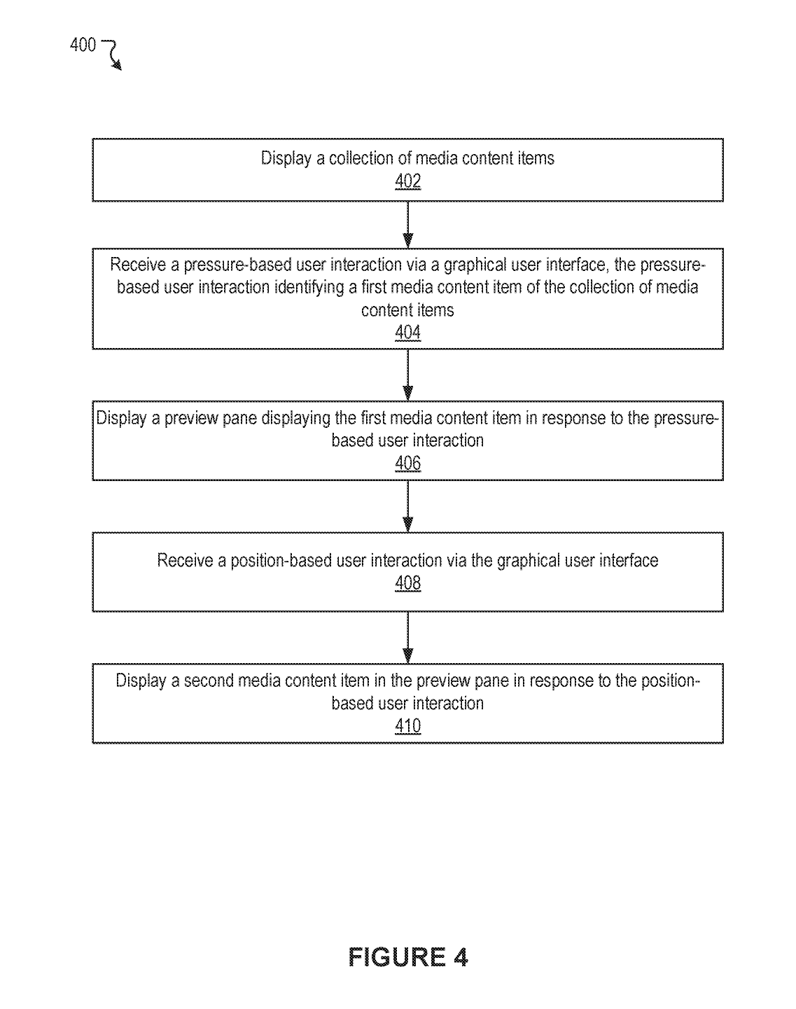

FIG. 4 illustrates an example method 400 associated with previewing media content items, according to an embodiment of the present disclosure. It should be appreciated that there can be additional, fewer, or alternative steps performed in similar or alternative orders, or in parallel, based on the various features and embodiments discussed herein unless otherwise stated.

At block 402, the example method 400 can display a collection of media content items. At block 404, the example method 400 can receive a pressure-based user interaction via a graphical user interface, the pressure-based user interaction identifying a first media content item of the collection of media content items. At block 406, the example method 400 can display a preview pane displaying the first media content item in response to the pressure-based user interaction. At block 408, the example method 400 can receive a position-based user interaction via the graphical user interface. At block 410, the example method 400 can display a second media content item in the preview pane in response to the position-based user interaction. Other suitable techniques that incorporate various features and embodiments of the present technology are possible.

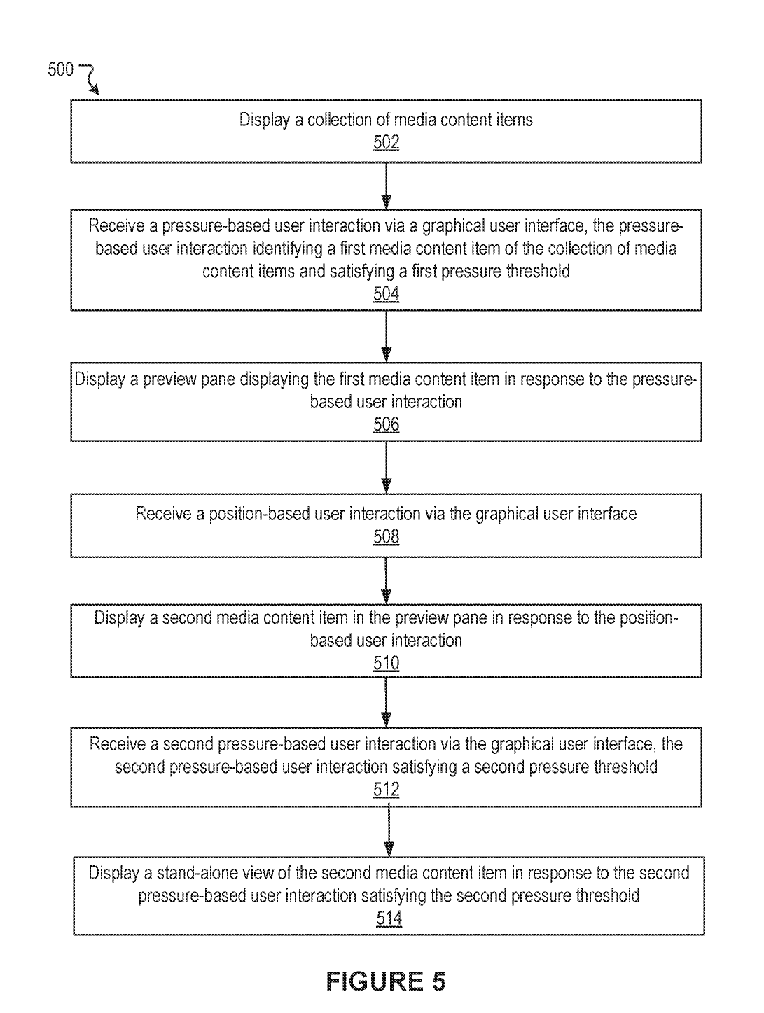

FIG. 5 illustrates an example method 500 associated with transitioning between a collection view, a preview view, and a stand-alone view, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can display a collection of media content items. At block 504, the example method 500 can receive a pressure-based user interaction via a graphical user interface, the pressure-based user interaction identifying a first media content item of the collection of media content items and satisfying a first pressure threshold. At block 506, the example method 500 can display a preview pane displaying the first media content item in response to the pressure-based user interaction. At block 508, the example method 500 can receive a position-based user interaction via the graphical user interface. At block 510, the example method 500 can display a second media content item in the preview pane in response to the position-based user interaction. At block 512, the example method 500 can receive a second pressure-based user interaction via the graphical user interface, the second pressure-based user interaction satisfying a second pressure threshold. At block 514, the example method 500 can display a stand-alone view of the second media content item in response to the second pressure-based interaction satisfying the second pressure threshold. Other suitable techniques that incorporate various features and embodiments of the present technology are possible.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the user device 610 can include a preview and scrub module 646. The preview and scrub module 646 can, for example, be implemented as the preview and scrub module 102, as discussed in more detail herein. As discussed previously, it should be appreciated that there can be many variations or other possibilities. For example, in some embodiments, one or more functionalities of the preview and scrub module 646 can be implemented in the social networking system 630.

### Hardware Implementation

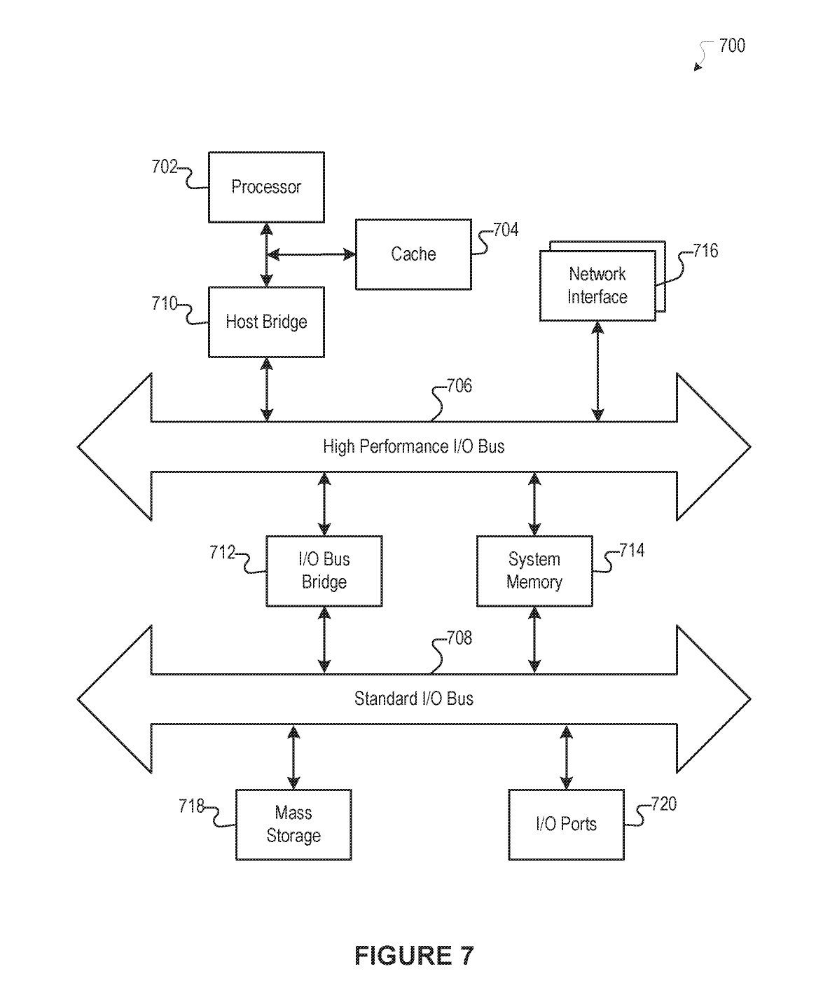

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
displaying, by a computing system, a collection of media content items;
receiving, by the computing system, a pressure-based user interaction via a graphical user interface, the pressure-based user interaction identifying a first media content item of the collection of media content items;
displaying, by the computing system, a preview pane displaying the first media content item in response to the pressure-based user interaction;
receiving, by the computing system, a position-based user interaction via the graphical user interface; and
displaying, by the computing system, a second media content item in the preview pane in response to the position-based user interaction.

2. The computer-implemented method of claim 1, wherein the pressure-based user interaction satisfies a first pressure threshold.

3. The computer-implemented method of claim 2, further comprising:
receiving an indication that the pressure-based user interaction no longer satisfies the first pressure threshold; and
ceasing display of the preview pane.

4. The computer-implemented method of claim 2, further comprising:
receiving a second pressure-based user interaction that satisfies a second pressure threshold; and
displaying a stand-alone view of the second media content item in response to the second pressure-based user interaction satisfying the second pressure threshold.

5. The computer-implemented method of claim 1, wherein the second media content is displayed in the preview pane in response to the position-based user interaction and continued receipt of the pressure-based user interaction.

6. The computer-implemented method of claim 5, wherein the position-based user interaction comprises a change in position of the pressure-based user interaction.

7. The computer-implemented method of claim 6, wherein
the pressure-based user interaction satisfies a pressure threshold, and
the position-based user interaction comprises a change in position of the pressure-based user interaction while the pressure-based user interaction continues to satisfy the pressure threshold.

8. The computer-implemented method of claim 1, wherein
the position-based user interaction comprises a change in position of the pressure-based user interaction, and
the displaying the second media content item in the preview pane occurs in response to the change in position of the pressure-based user interaction satisfying a distance threshold.

9. The computer-implemented method of claim 8, wherein the distance threshold is calculated based on a number of media content items in the collection of media content items.

10. The computer-implemented method of claim 1, wherein
the second media content item comprises a video media content item, and
the displaying the second media content item in the preview pane comprises playing the video media content item in the preview pane.

11. A system comprising:
at least one processor; and
a memory storing instructions that, when executed by the at least one processor, cause the system to perform a method comprising:
displaying a collection of media content items;
receiving a pressure-based user interaction via a graphical user interface, the pressure-based user interaction identifying a first media content item of the collection of media content items;
displaying a preview pane displaying the first media content item in response to the pressure-based user interaction;
receiving a position-based user interaction via the graphical user interface; and
displaying a second media content item in the preview pane in response to the position-based user interaction.

12. The system of claim 11, wherein the pressure-based user interaction satisfies a first pressure threshold.

13. The system of claim 12, wherein the method further comprises:
receiving an indication that the pressure-based user interaction no longer satisfies the first pressure threshold; and
ceasing display of the preview pane.

14. The system of claim 12, wherein the method further comprises:
receiving a second pressure-based user interaction that satisfies a second pressure threshold; and
displaying a stand-alone view of the second media content item in response to the second pressure-based user interaction satisfying the second pressure threshold.

15. The system of claim 11, wherein the second media content is displayed in the preview pane in response to the position-based user interaction and continued receipt of the pressure-based user interaction.

16. A non-transitory computer-readable storage medium including instructions that, when executed by at least one processor of a computing system, cause the computing system to perform a method comprising:
displaying a collection of media content items;
receiving a pressure-based user interaction via a graphical user interface, the pressure-based user interaction identifying a first media content item of the collection of media content items;
displaying a preview pane displaying the first media content item in response to the pressure-based user interaction;
receiving a position-based user interaction via the graphical user interface; and
displaying a second media content item in the preview pane in response to the position-based user interaction.

17. The non-transitory computer-readable storage medium of claim 16, wherein the pressure-based user interaction satisfies a first pressure threshold.

18. The non-transitory computer-readable storage medium of claim 17, wherein the method further comprises:
receiving an indication that the pressure-based user interaction no longer satisfies the first pressure threshold; and
ceasing display of the preview pane.

19. The non-transitory computer-readable storage medium of claim 17, wherein the method further comprises:
receiving a second pressure-based user interaction that satisfies a second pressure threshold; and
displaying a stand-alone view of the second media content item in response to the second pressure-based user interaction satisfying the second pressure threshold.

20. The non-transitory computer-readable storage medium of claim 16, wherein the second media content is displayed in the preview pane in response to the position-based user interaction and continued receipt of the pressure-based user interaction.
